(19) United States
(12) Patent Application Publication
(10) Pub. No.: US 2024/0089238 A1
(43) Pub. Date: Mar. 14, 2024

(54) MODEM PROCESSOR FIREWALL OPERATIONS

(71) Applicant: QUALCOMM Incorporated, San Diego, CA (US)

(72) Inventors: Ramu THONDAPU, Hyderabad (IN); Prasad GADDE, Hyderabad (IN); Suraj Darigonda PATIL, Kolhapur (IN)

(21) Appl. No.: 17/931,606

(22) Filed: Sep. 13, 2022

(51) Int. Cl. H04L 9/40

(52) U.S. Cl. CPC H04L 63/0263

(57) ABSTRACT

In aspects of modem processor firewall operations, an application processor may provide to a modem information related to one or more firewall rules configured to enable the modem to block data packets satisfying filter criteria consistent with the one or more firewall rules. A modem processor may receive from the application processor one or more firewall rules used by the application processor for performing firewall operations on received data packets, generate one or more filters executable by the modem processor based on the received one or more firewall rules for application to data packets received by the modem, and drop received data packets that meet blocking criteria of the generated one or more filters.

### BACKGROUND

Long Term Evolution (LTE), Fifth Generation (5G) New Radio (NR), and other communication technologies enable improved communication and data services. Modern communication devices often employ firewalls to protect devices and networks against malicious data or malicious code. Typically, a an application processor of a device executes all firewall rules. Conventionally, a modem processor of the device, in communication with the application processor, receives data from a radio frequency (RF) or wired interface (e.g., Ethernet), decodes received data, and passes the decoded data to the application processor. It is up to the application processor to execute firewall rules to protect the processor and connected devices from attacks. Thus, the processing burden of executing a firewall is imposed entirely on the application processor, requiring the processor to power up to execute firewall rules even if all received data packets are rejected.

### SUMMARY

Various aspects include systems and methods performed by a modem processor of a device for dropping received data packets meeting firewall blocking criteria, avoiding passing to the applications processor data packets that would be blocked by firewall rules executing in the applications processor. Various aspects include methods performed by a modem processor including receiving from an application processor one or more firewall rules used by the application processor for performing firewall operations on received data packets, generating one or more filters executable by the modem processor based on the received one or more firewall rules, and dropping received data packets that meet blocking criteria of the generated one or more filters.

In some aspects, generating one or more filters executable by the modem processor based on the received one or more firewall rules may include generating one or more filters based on received one or more firewall rules associated with one or more user plane connections maintained by the modem.

In some aspects, generating one or more filters executable by the modem processor based on the received one or more firewall rules may include parsing each firewall rule to identify firewall parameters and blocking operations applicable to the firewall rule, and generating a corresponding filter executable by the modem processor comprising filter criteria consistent with identified firewall parameters.

In some aspects, receiving from an application processor one or more firewall rules may include receiving from the application processor firewall rules applicable only to user plane connections maintained by the modem.

Further aspects include a modem including a modem processor configured to perform one or more operations of any of the methods summarized above. Further aspects include a modem having means for performing functions of any of the methods summarized above. Further aspects include a non-transitory processor-readable storage medium having stored thereon processor-executable instructions configured to cause a modem processor to perform operations of any of the methods summarized above.

In further aspects, an application processor may provide to a modem information related to one or more firewall rules configured to enable the modem to drop data packets satisfying filter criteria consistent with the one or more firewall rules. Some aspects include methods performed by an application processor including providing to a modem information related to one or more firewall rules configured to enable the modem to block data packets satisfying filter criteria consistent with the one or more firewall rules. In some aspects, providing to a modem information related to one or more firewall rules may include sending to the modem all firewall rules configured for use by the application processor. In some aspects, providing to a modem information related to one or more firewall rules may include sending to the modem only firewall rules that are applicable to one or more user plane connections maintained by the modem.

In some aspects, providing to a modem information related to one or more firewall rules configured to enable the modem to block data packets satisfying filter criteria consistent with the one or more firewall rules may include generating one or more filters executable by a modem based on the one or more firewall rules, in which the generated one or more filters comprise filter criteria consistent with the one or more firewall rules. In some aspects, generating one or more filters executable by the modem based on one or more firewall rules may include generating the one or more filters with filter criteria consistent with firewall parameters of the one or more firewall rules.

Further aspects include an application processor configured to perform one or more operations of any of the methods summarized above. Further aspects include an application processor having means for performing functions of any of the methods summarized above. Further aspects include a non-transitory processor-readable storage medium having stored thereon processor-executable instructions configured to cause an application processor to perform operations of any of the methods summarized above.

### BRIEF DESCRIPTION OF THE DRAWINGS

FIG. 1A is a system block diagram illustrating an example communications system suitable for implementing any of the various embodiments.

FIG. 1B is a system block diagram illustrating an example disaggregated base station architecture suitable for implementing any of the various embodiments.

FIG. 2 is a component block diagram illustrating an example computing and wireless modem system suitable for implementing any of the various embodiments.

FIG. 3 is a component block diagram illustrating a software architecture including a radio protocol stack for the user and control planes in wireless communications suitable for implementing any of the various embodiments.

FIG. 4 is a component block diagram illustrating elements of a device configured in accordance with various embodiments.

FIGS. 5A-5D are conceptual diagrams illustrating operations that may be performed by an application processor and a modem processor according to various embodiments.

FIG. 6A is a process flow diagram illustrating a method 600a performed by a modem processor of a modem in accordance with various embodiments.

FIG. 6B is a process flow diagram illustrating operations 600b that may be performed by a modem processor of a modem as part of the method 600a in accordance with various embodiments.

FIG. 7 is a process flow diagram illustrating a method 700 performed by an application processor of a device in accordance with various embodiments.

FIG. 8 is a component block diagram of a UE suitable for use with various embodiments.

FIG. 9 is a component block diagram of a network device suitable for use with various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Various embodiments enable a modem processor of a device to perform operations to filter out data packets that an connected application processor will otherwise block or drop based on firewall rules executing in the applications processor. In some embodiments, a modem processor generates the firewall filters based on firewall rules received from the application processor. In some embodiments, the application processor generates the firewall filters based on firewall rules and passes the generated filters to the modem for execution.

Various embodiments increase the efficiency of application processor operations by reducing the computational burden on the application processor required to execute firewall rules on data packets that will be blocked by such rules. Various embodiments particularly increase the efficiency of the application processor when the device is operating in a non-dormant or non-low power mode, such as Radio Resource Control (RRC) Active or Connected mode, when the modem is actively receiving data packets and the applications processor is standing by to receive data packets for processing. By the modem filtering out data packets that would be dropped anyway by the application processor's firewall rules, the application processor does not have to spend processing resources blocking such data packets.

The term “user equipment” (UE) is used herein to refer to any one or all of wireless communication devices, wireless appliances, cellular telephones, smartphones, portable computing devices, personal or mobile multi-media players, laptop computers, tablet computers, smartbooks, ultrabooks, palmtop computers, wireless electronic mail receivers, multimedia Internet-enabled cellular telephones, wireless router devices, medical devices and equipment, biometric sensors/devices, wearable devices including smart watches, smart clothing, smart glasses, smart wrist bands, smart jewelry (for example, smart rings and smart bracelets), entertainment devices (for example, wireless gaming controllers, music and video players, satellite radios, etc.), wireless-network enabled Internet of Things (IoT) devices including smart meters/sensors, industrial manufacturing equipment, large and small machinery and appliances for home or enterprise use, wireless communication elements within vehicles, wireless devices affixed to or incorporated into various mobile platforms, and similar electronic devices that include a memory, wireless communication components and a programmable processor.

The term “system on chip” (SOC) is used herein to refer to a single integrated circuit (IC) chip that contains multiple resources or processors integrated on a single substrate. A single SOC may contain circuitry for digital, analog, mixed-signal, and radio-frequency functions. A single SOC also may include any number of general purpose or specialized processors (digital signal processors, modem processors, video processors, etc.), memory blocks (such as ROM, RAM, Flash, etc.), and resources (such as timers, voltage regulators, oscillators, etc.). SOCs also may include software for controlling the integrated resources and processors, as well as for controlling peripheral devices.

The term “system in a package” (SIP) may be used herein to refer to a single module or package that contains multiple resources, computational units, cores or processors on two or more IC chips, substrates, or SOCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP also may include multiple independent SOCs coupled together via high speed communication circuitry and packaged in close proximity, such as on a single motherboard or in a single wireless device. The proximity of the SOCs facilitates high speed communications and the sharing of memory and resources.

As used herein, the terms “network,” “system,” “wireless network,” “cellular network,” and “wireless communication network” may interchangeably refer to a portion or all of a wireless network of a carrier associated with a wireless device and/or subscription on a wireless device. The techniques described herein may be used for various wireless communication networks, such as Code Division Multiple Access (CDMA), time division multiple access (TDMA), FDMA, orthogonal FDMA (OFDMA), single carrier FDMA (SC-FDMA) and other networks. In general, any number of wireless networks may be deployed in a given geographic area. Each wireless network may support at least one radio access technology, which may operate on one or more frequency or range of frequencies. For example, a CDMA network may implement Universal Terrestrial Radio Access (UTRA) (including Wideband Code Division Multiple Access (WCDMA) standards), CDMA2000 (including IS-2000, IS-95 and/or IS-856 standards), etc. In another example, a TDMA network may implement Enhanced Data rates for global system for mobile communications (GSM) Evolution (EDGE). In another example, an OFDMA network may implement Evolved UTRA (E-UTRA) (including LTE standards), Institute of Electrical and Electronics Engineers (IEEE) 802.11 (Wi-Fi), IEEE 802.16 (WiMAX), IEEE 802.20, Flash-OFDM@, etc. Reference may be made to wireless networks that use LTE standards, and therefore the terms “Evolved Universal Terrestrial Radio Access,” “E-UTRAN” and “eNodeB” may also be used interchangeably herein to refer to a wireless network. However, such references are provided merely as examples, and are not intended to exclude wireless networks that use other communication standards. For example, while various Third Generation (3G) systems, Fourth Generation (4G) systems, and Fifth Generation (5G) systems are discussed herein, those systems are referenced merely as examples and future generation systems (e.g., sixth generation (6G) or higher systems) may be substituted in the various examples.

Firewalls are an essential feature of modern communication devices, such as computing devices, mobile broadband routers, automotive telematics product, and/or numerous other devices. Firewalls are typically executed by an application processor of a device to analyze incoming data packets to identify and block malware and other forms of attack. Firewalls may include the execution of firewall rules on data traffic (e.g., protocol data units (PDUs)) received by (and/or sent by) received by the device, such as via a modem. Firewall rules may be applied to data traffic to drop malformed or unwanted data traffic received from a communication network.

As used herein, the term “drop” as is “drop data packets” refers to a variety of operations that may be performed on a data packet that meets defined blocking criteria and thus prevent the data traffic (one or more packets) from receiving further processing by an application processor and/or use in device operations. Thus dropping data packets, either in the modem executing filters or in the applications processor executing firewall rules may include blocking packets from further processing, ignoring packets, rejecting packets, sending packets to a sandbox environment (e.g., for analysis), deleting packets from memory (e.g., cache or buffer memory), and/or other operations that will prevent packets from being further processed. In the case of data packets dropped by the modem in various embodiments, “dropping data packets” involves not passing the data packets to the application processor (i.e., preventing the applications processor from receiving the data packets).

In some embodiments, firewalls may be employed at the level of a router the communication network to protect devices connected to, for example, a broadband network served by such router. In some routers (e.g., commercial routers), firewall features, functions, and parameters may be configured, modified, deleted, enabled, or disabled through a user interface such as a router's homepage application. In some embodiments, a router may provide an application may call one or more firewall APIs that are supported by software executed by an application processor that enables configuration of firewall rules (e.g., a Telematics software development kit such as TelSDK, a software suite such as Qualcomm Mobile Access Point (QCMAP), and/or another suitable application).

Firewall rules may be stored in an application processor for execution in the kernel, for example, the form of iptables in a netfilter framework. Such firewall rules may be applied or executed by the application processor to allow or block data packets received from another device such as a communication network. If one or more packets meet blocking criteria of a firewall rule, such packets are dropped according to the firewall rule (e.g., blocked from further processing, deleted from memory, ignored, etc.).

In a typical communication device, a device modem may receive and decode data packets and pass the decoded data packets to the application processor. The application processor may route or transmit the data packets to an embedded or tethered client. The modem typically does not execute or instantiate any aspect of the firewall rules that are configured and maintained at the application processor, and the modem typically cannot determine whether a received packet should be blocked according to such firewall rules.

In executing and applying the firewall rules, the application processor must fetch packets from a memory and apply the firewall rules, incurring substantial power consumption and processing resource burden. Firewall operations performed by the application processor consume bandwidth of the application processor, memory, and communication bus. For some application processors, such processing and bandwidth consumption may degrade the performance of other applications and a user experience, especially for processors or processing chipsets that are more resource constrained.

Various embodiments enable a modem processor of a device to effectively perform firewall operations by applying filters based on firewall rules to data packets as the data packets are received by the modem. In some embodiments, a modem processor may receive from an application processor one or more firewall rules used by the application processor for performing firewall operations on received data packets. In such embodiments, the firewall rules provided to the modem are the same firewall rules that are used by the application processor to determine whether received data packets should be blocked. In some embodiments, the modem processor may generate one or more filters executable by the modem processor based on the received one or more firewall rules for application to data packets received by the modem. Then using the generated filters, the modem may drop received data packets that meet blocking criteria of the generated one or more filters. In some embodiments, the modem processor may drop received data packets without passing such data packets to the application processor.

In some embodiments, the modem processor may generate one or more filters based on received one or more firewall rules associated with one or more user plane connections. As used herein, “user plane connection” refers to a communication link, bearer, or session that provides end-to-end user plane connectivity to a device, such as an Evolved Packet System (EPS) Bearer as may be used in connection with 4G communication systems, a PDU Session as may be used in connection with 5G communication systems, and any other suitable communication link, bearer, or session employed in current or in future (e.g., 6G, 7G, etc.) communication systems. For example, 4G communication systems use an EPS Bearer to provide end-to-end user plane connectivity between the UE and an Access Point Name (APN) through the Packet Gateway (P-GW). There is a one-to-one mapping between EPS Bearer and QoS profile, i.e., all packets belonging to a specific EPS Bearer have the same “Quality of Service Class Identifier” (QCI). As another example, 5G communication systems use a PDU Session to provide end-to-end user plane connectivity between the UE and a specific Data Network (DN) through the User Plane Function (UPF). A PDU Session supports one or more Quality of Service (QoS) Flows. There is a one-to-one mapping between QoS Flow and QoS profile, in which all packets belonging to a specific QoS Flow have the same 5G Quality of Service Identifier (5QI).

In some embodiments, the modem processor may generate the one or more filters executable by the modem processor based on the received one or more firewall rules by parsing each firewall rule to identify firewall parameters and blocking operations applicable to the firewall rule, and generating a corresponding filter executable by the modem processor comprising filter criteria consistent with identified firewall parameters. In some embodiments, the modem processor may receive from the application processor firewall rules applicable only to user plane connections maintained by the modem.

In some embodiments, the application processor may provide to the modem information related to one or more firewall rules with the information configured to enable the modem to drop data packets satisfying filter criteria consistent with the one or more firewall rules. In some embodiments, the application processor may send to the modem all firewall rules configured for use by the application processor.

In some embodiments, the application processor may sending to the modem only firewall rules that are applicable to one or more user plane connections maintained by the modem. For example, the application processor may scan, review, parse, or analyze the firewall rules to identify or determine firewall rules that are applicable to user plane connections maintained by the modem. In some embodiments, the application processor may identifying a parameter, an argument, or a term in a firewall rule indicating that the firewall rule is applicable to such user plane connections maintained by the modem.

In some embodiments, the application processor may generate one or more filters executable by a connected modem based on the one or more firewall rules, in which the generated one or more filters comprise filter criteria consistent with the one or more firewall rules. In some embodiments, the application processor may generate the one or more filters with filter criteria consistent with firewall parameters of the one or more firewall rules.

Various embodiments improve the operation of application processors and modem processors by reducing a processing burden of the application processor and increasing the ability of the application processor to execute other processes, enhancing overall application processor performance. Various embodiments improve the operation of communication devices by reducing power consumption when performing firewall operations. Various embodiments improve the operation of communication devices by reducing consumption of memory cache and communication bus resources of the device.

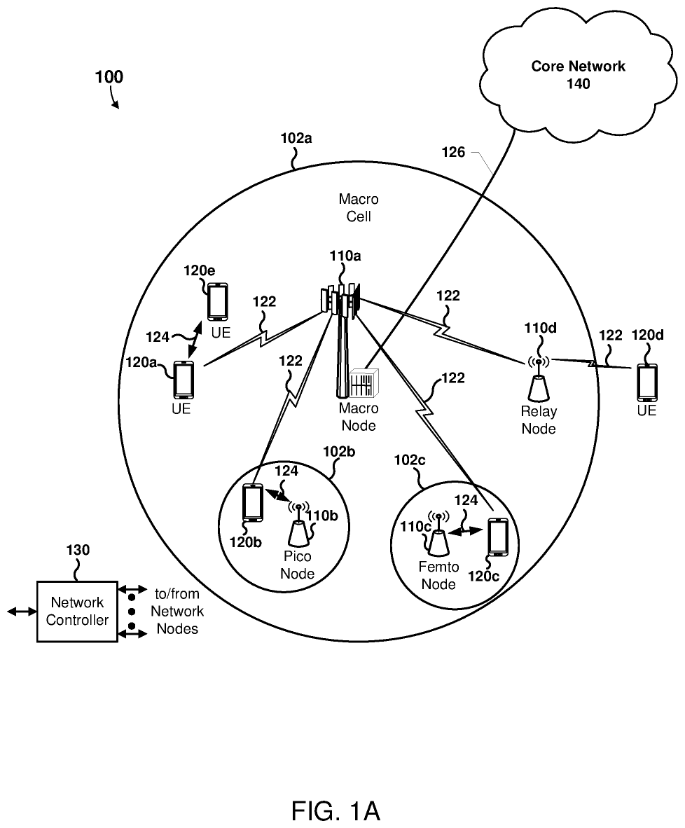

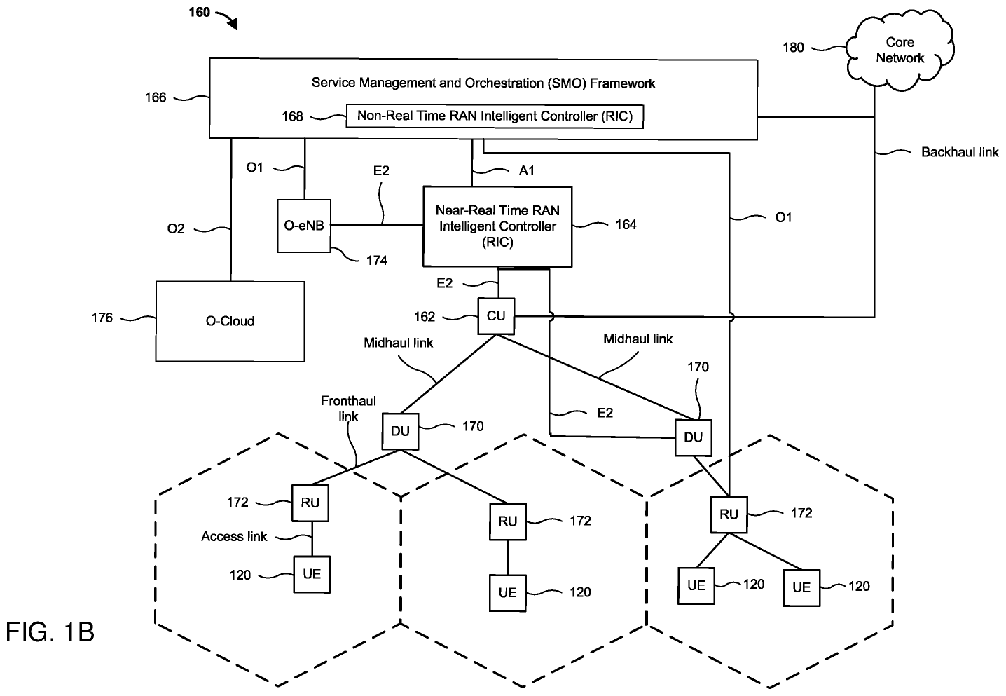

FIG. 1A is a system block diagram illustrating an example communications system 100 suitable for implementing any of the various embodiments. The communications system 100 may be a 5G New Radio (NR) network, or any other suitable network such as a Long Term Evolution (LTE) network. While FIG. 1A illustrates a 5G network, later generation networks may include the same or similar elements. Therefore, the reference to a 5G network and 5G network elements in the following descriptions is for illustrative purposes and is not intended to be limiting.

The communications system 100 may include a heterogeneous network architecture that includes a core network 140 and a variety of UEs (illustrated as UEs 120a-120e in FIG. 1A). The communications system 100 also may include a number of network devices 110a, 110b, 110c, and 110d and other network entities, such as base stations and network nodes. A network device is an entity that communicates with UEs, and in various embodiments may be referred to as a Node B, an LTE Evolved nodeB (eNodeB or eNB), an access point (AP), a radio head, a transmit receive point (TRP), a New Radio base station (NR BS), a 5G NodeB (NB), a Next Generation NodeB (gNodeB or gNB), or the like. In various communication network implementations or architectures, a network device may be implemented as an aggregated base station, as a disaggregated base station, an integrated access and backhaul (IAB) node, a relay node, a sidelink node, etc., such as a virtualized Radio Access Network (vRAN) or Open Radio Access Network (O-RAN). Also, in various communication network implementations or architectures, a network device (or network entity) may be implemented in an aggregated or monolithic base station architecture, or alternatively, in a disaggregated base station architecture, may include one or more of a Centralized Unit (CU), a Distributed Unit (DU), a Radio Unit (RU), a near-real time (RT) RAN intelligent controller (RIC), or a non-real time RIC. Each network device may provide communication coverage for a particular geographic area. In 3GPP, the term “cell” can refer to a coverage area of a network device, a network device subsystem serving this coverage area, or a combination thereof, depending on the context in which the term is used. The core network 140 may be any type core network, such as an LTE core network (e.g., an evolved packet core (EPC) network), 5G core network, etc.

A network device 110a-110d may provide communication coverage for a macro cell, a pico cell, a femto cell, another type of cell, or a combination thereof. A macro cell may cover a relatively large geographic area (for example, several kilometers in radius) and may allow unrestricted access by UEs with service subscription. A pico cell may cover a relatively small geographic area and may allow unrestricted access by UEs with service subscription. A femto cell may cover a relatively small geographic area (for example, a home) and may allow restricted access by UEs having association with the femto cell (for example, UEs in a closed subscriber group (CSG)). A network device for a macro cell may be referred to as a macro node or macro base station. A network device for a pico cell may be referred to as a pico node or a pico base station. A network device for a femto cell may be referred to as a femto node, a femto base station, a home node or home network device. In the example illustrated in FIG. 1A, a network device 110a may be a macro node for a macro cell 102a, a network device 110b may be a pico node for a pico cell 102b, and a network device 110c may be a femto node for a femto cell 102c. A network device 110a-110d may support one or multiple (for example, three) cells. The terms “network device,” “network node,” “eNB,” “base station,” “NR BS,” “gNB,” “TRP,” “AP,” “node B,” “5G NB,” and “cell” may be used interchangeably herein.

In some examples, a cell may not be stationary, and the geographic area of the cell may move according to the location of a network device, such as a network node or mobile network device. In some examples, the network devices 110a-110d may be interconnected to one another as well as to one or more other network devices (e.g., base stations or network nodes (not illustrated)) in the communications system 100 through various types of backhaul interfaces, such as a direct physical connection, a virtual network, or a combination thereof using any suitable transport network

The network device 110a-110d may communicate with the core network 140 over a wired or wireless communication link 126. The UE 120a-120e may communicate with the network node 110a-110d over a wireless communication link 122. The wired communication link 126 may use a variety of wired networks (such as Ethernet, TV cable, telephony, fiber optic and other forms of physical network connections) that may use one or more wired communication protocols, such as Ethernet, Point-To-Point protocol, High-Level Data Link Control (HDLC), Advanced Data Communication Control Protocol (ADCCP), and Transmission Control Protocol/Internet Protocol (TCP/IP).

The communications system 100 also may include relay stations (such as relay network device 110d). A relay station is an entity that can receive a transmission of data from an upstream station (for example, a network device or a UE) and send a transmission of the data to a downstream station (for example, a UE or a network device). A relay station also may be a UE that can relay transmissions for other UEs. In the example illustrated in FIG. 1A, a relay station 110d may communicate with macro the network device 110a and the UE 120d in order to facilitate communication between the network device 110a and the UE 120d. A relay station also may be referred to as a relay network device, a relay base station, a relay, etc.

The communications system 100 may be a heterogeneous network that includes network devices of different types, for example, macro network devices, pico network devices, femto network devices, relay network devices, etc. These different types of network devices may have different transmit power levels, different coverage areas, and different impacts on interference in communications system 100. For example, macro nodes may have a high transmit power level (for example, 5 to 40 Watts) whereas pico network devices, femto network devices, and relay network devices may have lower transmit power levels (for example, 0.1 to 2 Watts).

A network controller 130 may couple to a set of network devices and may provide coordination and control for these network devices. The network controller 130 may communicate with the network devices via a backhaul. The network devices also may communicate with one another, for example, directly or indirectly via a wireless or wireline backhaul.

The UEs 120a, 120b, 120c may be dispersed throughout communications system 100, and each UE may be stationary or mobile. A UE also may be referred to as an access terminal, a terminal, a mobile station, a subscriber unit, a station, wireless device, etc.

A macro network device 110a may communicate with the communication network 140 over a wired or wireless communication link 126. The UEs 120a, 120b, 120c may communicate with a network device 110a-110d over a wireless communication link 122.

The wireless communication links 122 and 124 may include a plurality of carrier signals, frequencies, or frequency bands, each of which may include a plurality of logical channels. The wireless communication links 122 and 124 may utilize one or more radio access technologies (RATs). Examples of RATs that may be used in a wireless communication link include 3GPP LTE, 3G, 4G, 5G (such as NR), GSM, Code Division Multiple Access (CDMA), Wideband Code Division Multiple Access (WCDMA), Worldwide Interoperability for Microwave Access (WiMAX), Time Division Multiple Access (TDMA), and other mobile telephony communication technologies cellular RATs. Further examples of RATs that may be used in one or more of the various wireless communication links within the communication system 100 include medium range protocols such as Wi-Fi, LTE-U, LTE-Direct, LAA, MuLTEfire, and relatively short range RATs such as ZigBee, Bluetooth, and Bluetooth Low Energy (LE).

Certain wireless networks (e.g., LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block”) may be 12 subcarriers (or 180 kHz). Consequently, the nominal Fast File Transfer (FFT) size may be equal to 128, 256, 512, 1024 or 2048 for system bandwidth of 1.25, 2.5, 5, 10 or 20 megahertz (MHz), respectively. The system bandwidth also may be partitioned into subbands. For example, a subband may cover 1.08 MHz (i.e., 6 resource blocks), and there may be 1, 2, 4, 8 or 16 subbands for system bandwidth of 1.25, 2.5, 5, 10 or 20 MHz, respectively.

While descriptions of some implementations may use terminology and examples associated with LTE technologies, some implementations may be applicable to other wireless communications systems, such as a new radio (NR) or 5G network. NR may utilize OFDM with a cyclic prefix (CP) on the uplink (UL) and downlink (DL) and include support for half-duplex operation using Time Division Duplex (TDD). A single component carrier bandwidth of 100 MHz may be supported. NR resource blocks may span 12 sub-carriers with a sub-carrier bandwidth of 75 kHz over a 0.1 millisecond (ms) duration. Each radio frame may consist of 50 subframes with a length of 10 ms. Consequently, each subframe may have a length of 0.2 ms. Each subframe may indicate a link direction (i.e., DL or UL) for data transmission and the link direction for each subframe may be dynamically switched. Each subframe may include DL/UL data as well as DL/UL control data. Beamforming may be supported and beam direction may be dynamically configured. Multiple Input Multiple Output (MIMO) transmissions with precoding also may be supported. MIMO configurations in the DL may support up to eight transmit antennas with multi-layer DL transmissions up to eight streams and up to two streams per UE. Multi-layer transmissions with up to 2 streams per UE may be supported.

Aggregation of multiple cells may be supported with up to eight serving cells. Alternatively, NR may support a different air interface, other than an OFDM-based air interface.

Some UEs may be considered machine-type communication (MTC) or evolved or enhanced machine-type communication (eMTC) UEs. MTC and eMTC UEs include, for example, robots, remote devices, sensors, meters, monitors, location tags, etc., that may communicate with a network device, another device (for example, remote device), or some other entity. A wireless computing platform may provide, for example, connectivity for or to a network (for example, a wide area network such as Internet or a cellular network) via a wired or wireless communication link. Some UEs may be considered Internet-of-Things (IoT) devices or may be implemented as NB-IoT (narrowband internet of things) devices. The UE 120a-120e may be included inside a housing that houses components of the UE 120a-120e, such as processor components, memory components, similar components, or a combination thereof.

In general, any number of communications systems and any number of wireless networks may be deployed in a given geographic area. Each communications system and wireless network may support a particular radio access technology (RAT) and may operate on one or more frequencies. A RAT also may be referred to as a radio technology, an air interface, etc. A frequency also may be referred to as a carrier, a frequency channel, etc. Each frequency may support a single RAT in a given geographic area in order to avoid interference between communications systems of different RATs. In some cases, 4G/LTE and/or 5G/NR RAT networks may be deployed. For example, a 5G non-standalone (NSA) network may utilize both 4G/LTE RAT in the 4G/LTE RAN side of the 5G NSA network and 5G/NR RAT in the 5G/NR RAN side of the 5G NSA network. The 4G/LTE RAN and the 5G/NR RAN may both connect to one another and a 4G/LTE core network (e.g., an EPC network) in a 5G NSA network. Other example network configurations may include a 5G standalone (SA) network in which a 5G/NR RAN connects to a 5G core network.

In some implementations, two or more UEs 120a-120e (for example, illustrated as the UE 120a and the UE 120e) may communicate directly using one or more sidelink channels 124 (for example, without using a network node 110a-110d as an intermediary to communicate with one another). For example, the UEs 120a-120e may communicate using peer-to-peer (P2P) communications, device-to-device (D2D) communications, a mesh network, or similar networks, a vehicle-to-everything (V2X) protocol (which may include a vehicle-to-vehicle (V2V) protocol, a vehicle-to-infrastructure (V2I) protocol, or a similar protocol), or combinations thereof. In this case, the UE 120a-120e may perform scheduling operations, resource selection operations, as well as other operations described elsewhere herein as being performed by the network node 110a-110d.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or components) performing base station functionality, may be implemented in an aggregated or disaggregated architecture. For example, a base station (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or as a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CUs, DUs and RUs also can be implemented as virtual units, referred to as a virtual central unit (VCU), a virtual distributed unit (VDU), or a virtual radio unit (VRU).

Base station-type operations or network design may consider aggregation characteristics of base station functionality. For example, disaggregated base stations may be utilized in an integrated access backhaul (IAB) network, an open radio access network (O-RAN) (such as the network configuration sponsored by the O-RAN Alliance), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

FIG. 1B is a system block diagram illustrating an example disaggregated base station 160 architecture suitable for implementing any of the various embodiments. With reference to FIGS. 1A and 1B, the disaggregated base station 160 architecture may include one or more central units (CUs) 162 that can communicate directly with a core network 180 via a backhaul link, or indirectly with the core network 180 through one or more disaggregated base station units, such as a Near-Real Time (Near-RT) RAN Intelligent Controller (RIC) 164 via an E2 link, or a Non-Real Time (Non-RT) RIC 168 associated with a Service Management and Orchestration (SMO) Framework 166, or both. A CU 162 may communicate with one or more distributed units (DUs) 170 via respective midhaul links, such as an F1 interface. The DUs 170 may communicate with one or more radio units (RUs) 172 via respective fronthaul links. The RUs 172 may communicate with respective UEs 120 via one or more radio frequency (RF) access links. In some implementations, the UE 120 may be simultaneously served by multiple RUs 172.

Each of the units (i.e., CUs 162, DUs 170, RUs 172), as well as the Near-RT RICs 164, the Non-RT RICs 168 and the SMO Framework 166, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 162 may host one or more higher layer control functions. Such control functions may include the radio resource control (RRC), packet data convergence protocol (PDCP), service data adaptation protocol (SDAP), or the like. Each control function may be implemented with an interface configured to communicate signals with other control functions hosted by the CU 162. The CU 162 may be configured to handle user plane functionality (i.e., Central Unit—User Plane (CU-UP)), control plane functionality (i.e., Central Unit—Control Plane (CU-CP)), or a combination thereof. In some implementations, the CU 162 can be logically split into one or more CU-UP units and one or more CU-CP units. The CU-UP unit can communicate bidirectionally with the CU-CP unit via an interface, such as the E1 interface when implemented in an O-RAN configuration. The CU 162 can be implemented to communicate with DUs 170, as necessary, for network control and signaling.

The DU 170 may correspond to a logical unit that includes one or more base station functions to control the operation of one or more RUs 172. In some aspects, the DU 170 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 170 may further host one or more low PHY layers. Each layer (or module) may be implemented with an interface configured to communicate signals with other layers (and modules) hosted by the DU 170, or with the control functions hosted by the CU 162.

Lower-layer functionality may be implemented by one or more RUs 172. In some deployments, an RU 172, controlled by a DU 170, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 172 may be implemented to handle over the air (OTA) communication with one or more UEs 120. In some implementations, real-time and non-real-time aspects of control and user plane communication with the RU(s) 172 may be controlled by the corresponding DU 170. In some scenarios, this configuration may enable the DU(s) 170 and the CU 162 to be implemented in a cloud-based RAN architecture, such as a vRAN architecture.

The SMO Framework 166 may be configured to support RAN deployment and provisioning of non-virtualized and virtualized network elements. For non-virtualized network elements, the SMO Framework 166 may be configured to support the deployment of dedicated physical resources for RAN coverage requirements, which may be managed via an operations and maintenance interface (such as an O1 interface). For virtualized network elements, the SMO Framework 166 may be configured to interact with a cloud computing platform (such as an open cloud (O-Cloud) 176) to perform network element life cycle management (such as to instantiate virtualized network elements) via a cloud computing platform interface (such as an O2 interface). Such virtualized network elements can include, but are not limited to, CUs 162, DUs 170, RUs 172 and Near-RT RICs 164. In some implementations, the SMO Framework 166 may communicate with a hardware aspect of a 4G RAN, such as an open eNB (O-eNB) 174, via an O1 interface. Additionally, in some implementations, the SMO Framework 166 may communicate directly with one or more RUs 172 via an O1 interface. The SMO Framework 166 also may include a Non-RT RIC 168 configured to support functionality of the SMO Framework 166.

The Non-RT RIC 168 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 164. The Non-RT RIC 168 may be coupled to or communicate with (such as via an A1 interface) the Near-RT RIC 164. The Near-RT RIC 164 may be configured to include a logical function that enables near-real-time control and optimization of RAN elements and resources via data collection and actions over an interface (such as via an E2 interface) connecting one or more CUs 162, one or more DUs 170, or both, as well as an O-eNB, with the Near-RT RIC 164.

In some implementations, to generate AI/ML models to be deployed in the Near-RT RIC 164, the Non-RT RIC 168 may receive parameters or external enrichment information from external servers. Such information may be utilized by the Near-RT RIC 164 and may be received at the SMO Framework 166 or the Non-RT RIC 168 from non-network data sources or from network functions. In some examples, the Non-RT RIC 168 or the Near-RT RIC 164 may be configured to tune RAN behavior or performance. For example, the Non-RT RIC 168 may monitor long-term trends and patterns for performance and employ AI/ML models to perform corrective actions through the SMO Framework 166 (such as reconfiguration via O1) or via creation of RAN management policies (such as A1 policies).

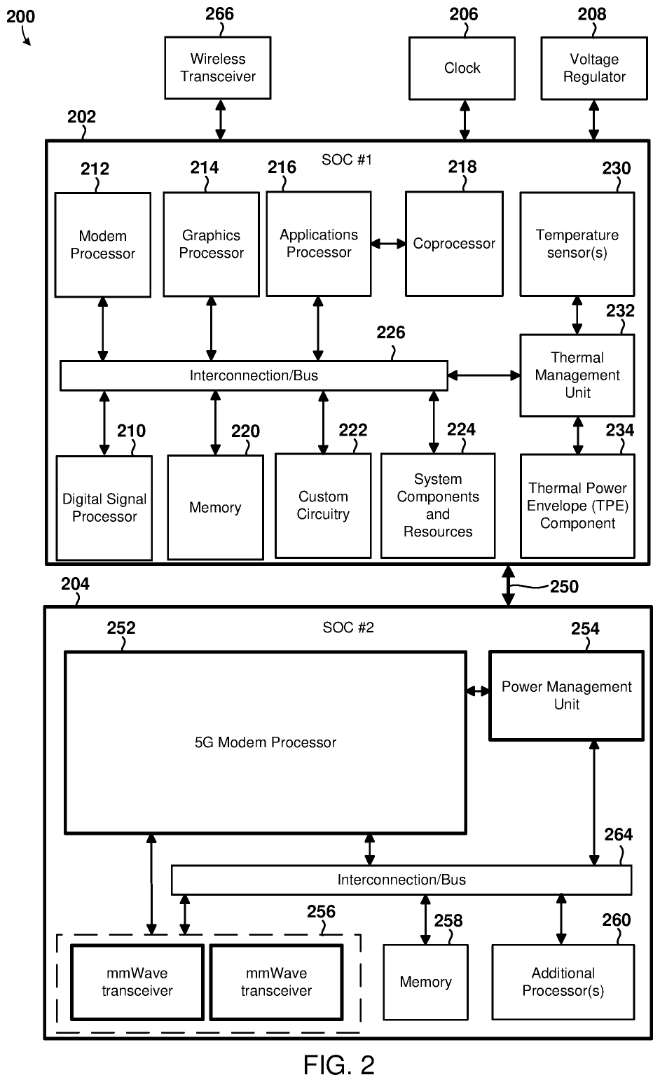

FIG. 2 is a component block diagram illustrating an example computing and wireless modem system 200 suitable for implementing any of the various embodiments. Various embodiments may be implemented on a number of single processor and multiprocessor computer systems, including a system-on-chip (SOC) or system in a package (SIP).

With reference to FIGS. 1A-2, the illustrated example computing system 200 (which may be a SIP in some embodiments) includes a two SOCs 202, 204 coupled to a clock 206, a voltage regulator 208, and a wireless transceiver 266 configured to send and receive wireless communications via an antenna (not shown) to/from a UE (e.g., 120a-120e) or a network device (e.g., 110a-110d).

In some implementations, the first SOC 202 may operate as central processing unit (CPU) of the UE that carries out the instructions of software application programs by performing the arithmetic, logical, control and input/output (I/O) operations specified by the instructions. In some implementations, the second SOC 204 may operate as a specialized processing unit. For example, the second SOC 204 may operate as a specialized 5G processing unit responsible for managing high volume, high speed (such as 5 Gbps, etc.), and/or very high frequency short wave length (such as 28 GHz mmWave spectrum, etc.) communications.

The first SOC 202 may include a digital signal processor (DSP) 210, a modem processor 212, a graphics processor 214, an application processor 216, one or more coprocessors 218 (such as vector co-processor) connected to one or more of the processors, memory 220, custom circuitry 222, system components and resources 224, an interconnection/bus module 226, one or more temperature sensors 230, a thermal management unit 232, and a thermal power envelope (TPE) component 234. The second SOC 204 may include a 5G modem processor 252, a power management unit 254, an interconnection/bus module 264, a plurality of mmWave transceivers 256, memory 258, and various additional processors 260, such as an applications processor, packet processor, etc.

Each processor 210, 212, 214, 216, 218, 252, 260 may include one or more cores, and each processor/core may perform operations independent of the other processors/cores. For example, the first SOC 202 may include a processor that executes a first type of operating system (such as FreeBSD, LINUX, OS X, etc.) and a processor that executes a second type of operating system (such as MICROSOFT WINDOWS 10). In addition, any or all of the processors 210, 212, 214, 216, 218, 252, 260 may be included as part of a processor cluster architecture (such as a synchronous processor cluster architecture, an asynchronous or heterogeneous processor cluster architecture, etc.).

The first and second SOC 202, 204 may include various system components, resources and custom circuitry for managing sensor data, analog-to-digital conversions, wireless data transmissions, and for performing other specialized operations, such as decoding data packets and processing encoded audio and video signals for rendering in a web browser. For example, the system components and resources 224 of the first SOC 202 may include power amplifiers, voltage regulators, oscillators, phase-locked loops, peripheral bridges, data controllers, memory controllers, system controllers, access ports, timers, and other similar components used to support the processors and software clients running on a UE. The system components and resources 224 and/or custom circuitry 222 also may include circuitry to interface with peripheral devices, such as cameras, electronic displays, wireless communication devices, external memory chips, etc.

The first and second SOC 202, 204 may communicate via interconnection/bus module 250. The various processors 210, 212, 214, 216, 218, may be interconnected to one or more memory elements 220, system components and resources 224, and custom circuitry 222, and a thermal management unit 232 via an interconnection/bus module 226. Similarly, the processor 252 may be interconnected to the power management unit 254, the mmWave transceivers 256, memory 258, and various additional processors 260 via the interconnection/bus module 264. The interconnection/bus module 226, 250, 264 may include an array of reconfigurable logic gates and/or implement a bus architecture (such as CoreConnect, AMBA, etc.). Communications may be provided by advanced interconnects, such as high-performance networks-on chip (NoCs).

The first and/or second SOCs 202, 204 may further include an input/output module (not illustrated) for communicating with resources external to the SOC, such as a clock 206 and a voltage regulator 208. Resources external to the SOC (such as clock 206, voltage regulator 208) may be shared by two or more of the internal SOC processors/cores.

In addition to the example SIP 200 discussed above, some implementations may be implemented in a wide variety of computing systems, which may include a single processor, multiple processors, multicore processors, or any combination thereof.

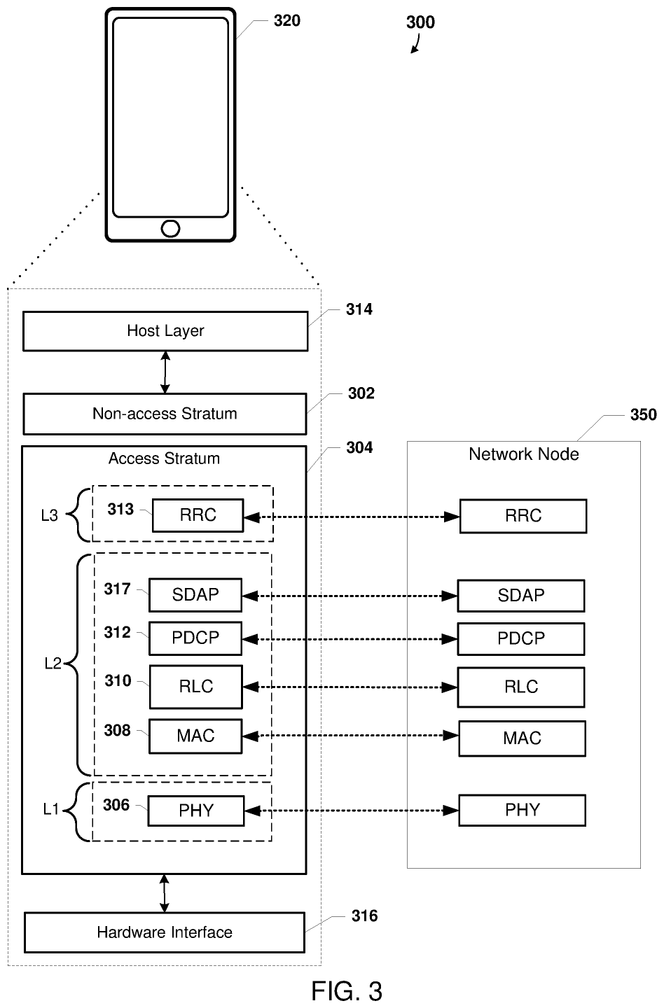

FIG. 3 is a component block diagram illustrating a software architecture 300 including a radio protocol stack for the user and control planes in wireless communications suitable for implementing any of the various embodiments. With reference to FIGS. 1A-3, the UE 320 may implement the software architecture 300 to facilitate communication between a UE 320 (e.g., the UE 120a-120e, 200) and the network device 350 (e.g., the network device 110a-110d) of a communication system (e.g., 100). In various embodiments, layers in software architecture 300 may form logical connections with corresponding layers in software of the network device 350. The software architecture 300 may be distributed among one or more processors (e.g., the processors 212, 214, 216, 218, 252, 260). While illustrated with respect to one radio protocol stack, in a UE having a multi-subscriber identity module (SIM), the software architecture 300 may include multiple protocol stacks, each of which may be associated with a different SIM (e.g., two protocol stacks associated with two SIMs, respectively, in a dual-SIM wireless communication device). While described below with reference to LTE communication layers, the software architecture 300 may support any of variety of standards and protocols for wireless communications, and/or may include additional protocol stacks that support any of variety of standards and protocols wireless communications.

The software architecture 300 may include a Non-Access Stratum (NAS) 302 and an Access Stratum (AS) 304. The NAS 302 may include functions and protocols to support packet filtering, security management, mobility control, session management, and traffic and signaling between a SIM(s) of the UE (such as SIM(s) 204) and its core network 140. The AS 304 may include functions and protocols that support communication between a SIM(s) (such as SIM(s) 204) and entities of supported access networks (such as a network device, network node, RU, base station, etc.). In particular, the AS 304 may include at least three layers (Layer 1, Layer 2, and Layer 3), each of which may contain various sub-layers.

In the user and control planes, Layer 1 (L1) of the AS 304 may be a physical layer (PHY) 306, which may oversee functions that enable transmission and/or reception over the air interface via a wireless transceiver (e.g., 266). Examples of such physical layer 306 functions may include cyclic redundancy check (CRC) attachment, coding blocks, scrambling and descrambling, modulation and demodulation, signal measurements, MIMO, etc. The physical layer may include various logical channels, including the Physical Downlink Control Channel (PDCCH) and the Physical Downlink Shared Channel (PDSCH).

In the user and control planes, Layer 2 (L2) of the AS 304 may be responsible for the link between the UE 320 and the network node 350 over the physical layer 306. In some implementations, Layer 2 may include a media access control (MAC) sublayer 308, a radio link control (RLC) sublayer 310, and a packet data convergence protocol (PDCP) 312 sublayer, and a Service Data Adaptation Protocol (SDAP) 317 sublayer, each of which form logical connections terminating at the network node 350.

In the control plane, Layer 3 (L3) of the AS 304 may include a radio resource control (RRC) sublayer 3. While not shown, the software architecture 300 may include additional Layer 3 sublayers, as well as various upper layers above Layer 3. In some implementations, the RRC sublayer 313 may provide functions including broadcasting system information, paging, and establishing and releasing an RRC signaling connection between the UE 320 and the network node 350.

In various embodiments, the SDAP sublayer 317 may provide mapping between Quality of Service (QoS) flows and data radio bearers (DRBs). In some implementations, the PDCP sublayer 312 may provide uplink functions including multiplexing between different radio bearers and logical channels, sequence number addition, handover data handling, integrity protection, ciphering, and header compression. In the downlink, the PDCP sublayer 312 may provide functions that include in-sequence delivery of data packets, duplicate data packet detection, integrity validation, deciphering, and header decompression.

In the uplink, the RLC sublayer 310 may provide segmentation and concatenation of upper layer data packets, retransmission of lost data packets, and Automatic Repeat Request (ARQ). In the downlink, while the RLC sublayer 310 functions may include reordering of data packets to compensate for out-of-order reception, reassembly of upper layer data packets, and ARQ.

In the uplink, MAC sublayer 308 may provide functions including multiplexing between logical and transport channels, random access procedure, logical channel priority, and hybrid-ARQ (HARQ) operations. In the downlink, the MAC layer functions may include channel mapping within a cell, de-multiplexing, discontinuous reception (DRX), and HARQ operations.

While the software architecture 300 may provide functions to transmit data through physical media, the software architecture 300 may further include at least one host layer 314 to provide data transfer services to various applications in the UE 320. In some implementations, application-specific functions provided by the at least one host layer 314 may provide an interface between the software architecture and the general purpose processor (e.g., 202).

In other implementations, the software architecture 300 may include one or more higher logical layer (such as transport, session, presentation, application, etc.) that provide host layer functions. For example, in some implementations, the software architecture 300 may include a network layer (such as Internet Protocol (IP) layer) in which a logical connection terminates at a packet data network (PDN) gateway (PGW). In some implementations, the software architecture 300 may include an application layer in which a logical connection terminates at another device (such as end user device, server, etc.). In some implementations, the software architecture 300 may further include in the AS 304 a hardware interface 316 between the physical layer 306 and the communication hardware (such as one or more radio frequency (RF) transceivers).

In various network implementations or architectures, in the network device 350 the different logical layers 308-317 may be implemented in an aggregated or monolithic base station architecture, or alternatively, in a disaggregated network device architecture, and various logical layers may implemented in one or more of a CU, a DU, an RU, a Near-RT RAN Intelligent Controller (RIC), or a Non-Real Time (Non-RT) RIC. Further, the network device 350 may be implemented as an aggregated base station, as a disaggregated base station, an integrated access and backhaul (IAB) node, a relay node, a sidelink node, etc.

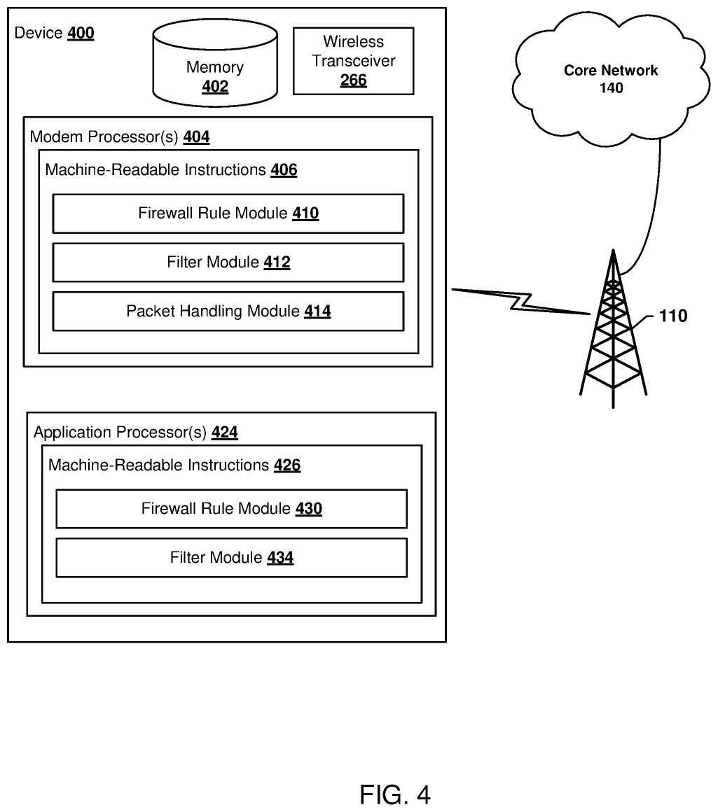

FIG. 4 is a component block diagram illustrating elements of a device 400 configured in accordance with various embodiments. With reference to FIGS. 1A-4, the device 400 (e.g., 120a-120e, 320) may be configured to communicate with a core network 140 via a base station 110.

The device 400 may include one or more modem processors 404, application processors 424, memory 402, a wireless transceiver 266, and other components. The device 400 may include a plurality of hardware, software, and/or firmware components operating together to provide the functionality attributed herein to the modem processors 404 and the application processors 424.

The memory 402 may include non-transitory storage media that electronically stores information. The electronic storage media of memory 402 may include one or both of system storage that is provided integrally (i.e., substantially non-removable) with the vehicle processing system 104 and/or removable storage that is removably connectable to the device 400 via, for example, a port (e.g., a universal serial bus (USB) port, a firewire port, etc.) or a drive (e.g., a disk drive, etc.). In various embodiments, memory 402 may include one or more of electrical charge-based storage media (e.g., EEPROM, RAM, etc.), solid-state storage media (e.g., flash drive, etc.), optically readable storage media (e.g., optical disks, etc.), magnetically readable storage media (e.g., magnetic tape, magnetic hard drive, floppy drive, etc.), and/or other electronically readable storage media.

The memory 402 may include one or more virtual storage resources (e.g., cloud storage, a virtual private network, and/or other virtual storage resources). Memory 402 may store software algorithms, information determined by application processor(s) 424, information received from another device, from a network element of the core network 140, information received from the base station 110, and/or other information that enables the device 400 to function as described herein.

The processor(s) 404 and 424 may include one of more local processors that may be configured to provide information processing capabilities in the device 400. As such, the processor(s) 404 and 424 may include one or more of a digital processor, an analog processor, a digital circuit designed to process information, an analog circuit designed to process information, a state machine, and/or other mechanisms for electronically processing information. Although the 404 and 424 are shown in FIG. 4 as single entities, this is for illustrative purposes only. In some embodiments, the 404 and 424 may include a plurality of processing units. These processing units may be physically located within the same device, or the 404 and 424 may represent processing functionality of a plurality of devices distributed in the vehicle and operating in coordination.

The modem processor(s) 404 may be configured by machine-readable instructions 406, which may include one or more instruction modules. The instruction modules may include computer program modules. In various embodiments, the instruction modules may include one or more of a firewall rule module 410, a filter module 412, a packet handling module 414, and/or other modules.

The firewall rule module 410 may be configured to receive from the application processor(s) 424 one or more firewall rules used by the application processor(s) 424 for performing firewall operations on received data packets. The firewall rule module 410 may be configured to receive from the application processor firewall rules applicable only to user plane connections maintained by the modem.

The filter module 412 may be configured to generate one or more filters executable by the modem processor based on the received one or more firewall rules for application to data packets received by the modem. The filter module 412 may be configured to generate one or more filters based on received one or more firewall rules associated with one or more user plane connections. The filter module 412 may be configured to parse each firewall rule to identify firewall parameters and blocking operations applicable to the firewall rule, and generate a corresponding filter executable by the modem processor comprising filter criteria consistent with identified firewall parameters.

The packet handling module 338 may be configured to drop received data packets that meet blocking criteria of the generated one or more filters

The application processor(s) 424 may be configured by machine-readable instructions 426, which may include one or more instruction modules. The instruction modules may include computer program modules. In various embodiments, the instruction modules may include one or more of a firewall rule module 430, a filter module 434, and/or other modules.

The firewall rule module 430 may be configured to provide to a modem information related to one or more firewall rules configured to enable the modem to block data packets satisfying filter criteria consistent with the one or more firewall rules. The firewall rule module 430 may be configured to send to the modem all firewall rules configured for use by the application processor. The firewall rule module 430 may be configured to send to the modem only firewall rules that are applicable to one or more user plane connections maintained by the modem.

Filter module 434 may be configured to generate one or more filters executable by a modem based on the one or more firewall rules, wherein the generated one or more filters comprise filter criteria consistent with the one or more firewall rules. Filter module 434 may be configured to generate the one or more filters with filter criteria consistent with firewall parameters of the one or more firewall rules.

The processor(s) 404 and 424 may be configured to execute the modules 434-442 and/or other modules by software, hardware, firmware, some combination of software, hardware, and/or firmware, and/or other mechanisms for configuring processing capabilities on processor(s) 404 and 424.

The description of the functionality provided by the different modules 410-414 and 426-434 is for illustrative purposes, and is not intended to be limiting, as any of modules 410-414 and 426-434 may provide more or less functionality than is described. For example, one or more of modules 410-414 and 426-434 may be eliminated, and some or all of its functionality may be provided by other ones of modules 410-414 and 426-434. As another example, processor(s) 404 may be configured to execute one or more additional modules that may perform some or all of the functionality attributed below to one of modules 410-414 and 426-434.

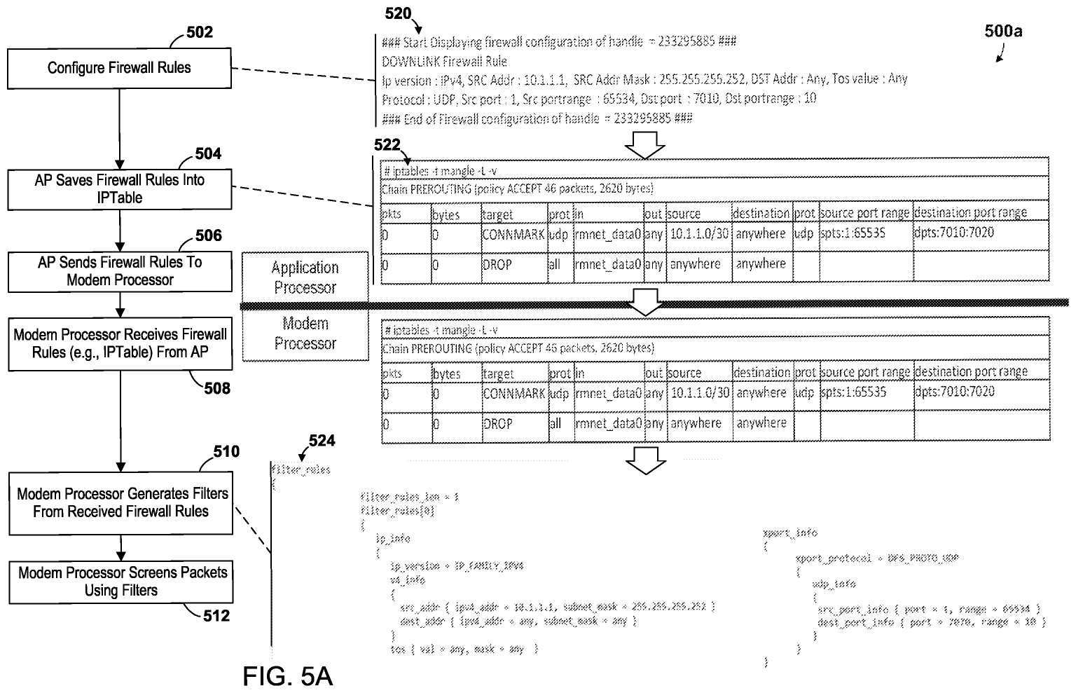

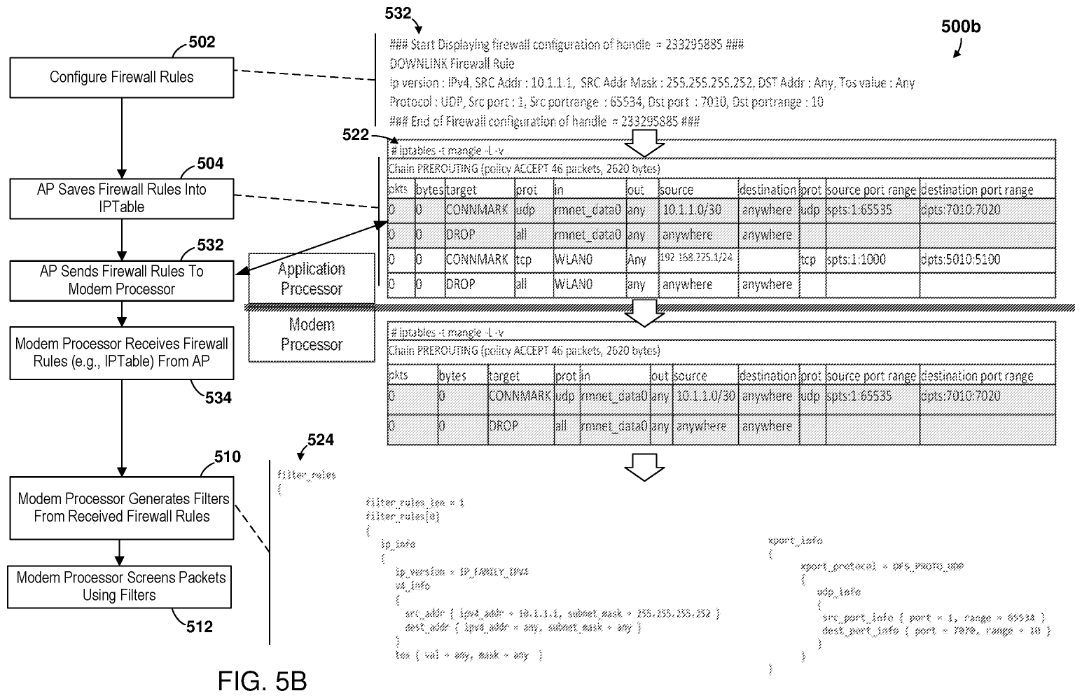

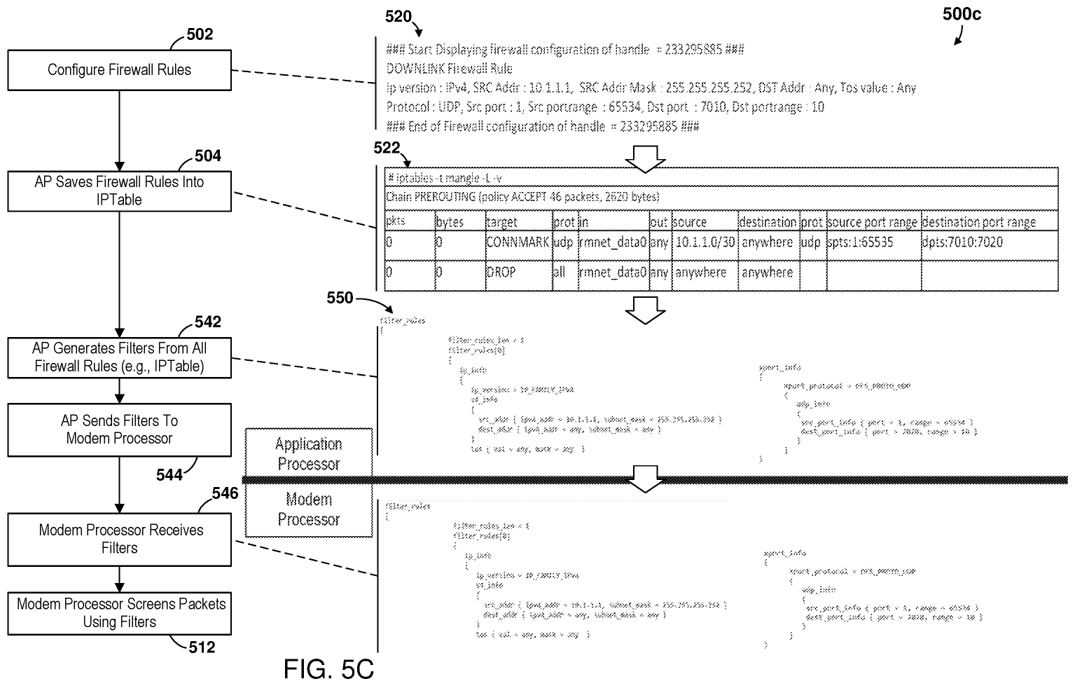

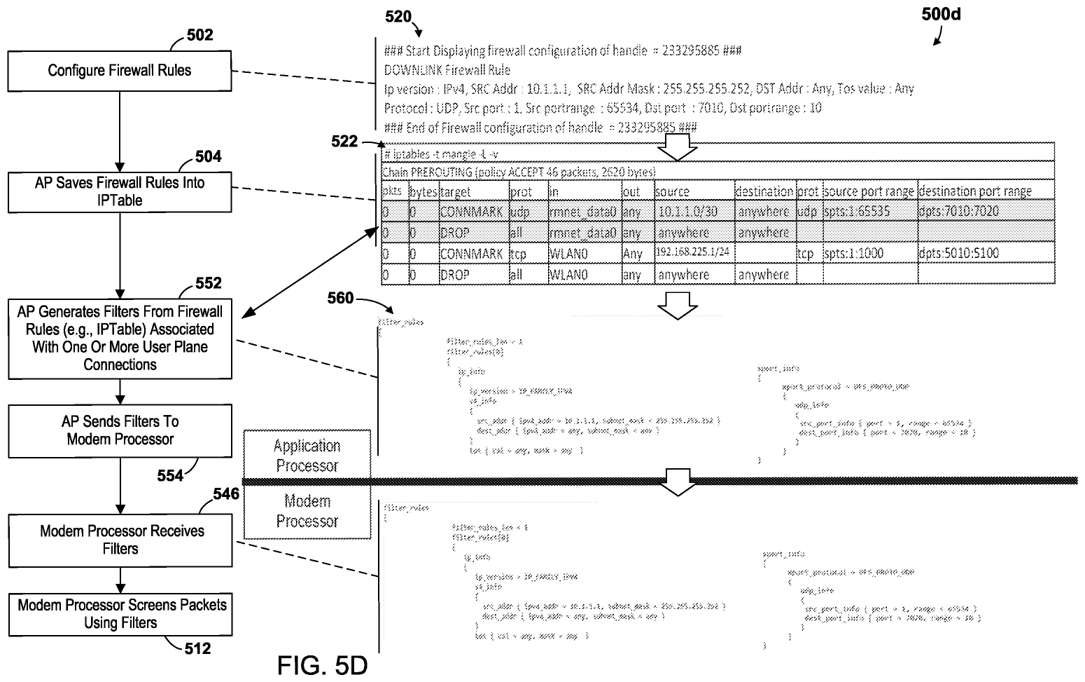

FIGS. 5A-5D are conceptual diagrams illustrating non-limiting examples of operations 500a-500d that may be performed by an application processor (AP) and a modem processor according to various embodiments. With reference to FIGS. 1A-5D, the operations 500a-500d may be performed by a processor (such as the processor 210, 212, 214, 216, 218, 252, 260, 404, 424) of a UE (such as the UE 120a-120e, 200, 320, 400).

Referring to FIG. 5A, the application processor may configure firewall rules in operation 502. In some embodiments, the application processor may receive firewall configuration information, such as various firewall parameters, from a user input, a configuration file, or another suitable source of firewall configuration information. For example, the application processor may configure firewall rules 520 based on the firewall configuration information.

In operation 504, the application processor may save the firewall rules in a data structure. In some embodiments, the data structure may include an IP Table 522. In some embodiments, the firewall rules in the data structure may be in a form or format that is executable by the application processor.

In operation 506, the application processor may send the firewall rules 522 to the modem processor.

In operation 508, the modem processor may receive the firewall rules from the application processor.

In operation 510, the modem processor may generate filters from the received firewall rules. In some embodiments, the modem processor may generate the filters in a data structure, such as the data structure of the filters 524.

In some embodiments, the generated filters are executable by the modem processor.

In operation 512, the modem processor may screen packets using the filters. In some embodiments, the modem processor may drop received data packets that meet blocking criteria of the filters. In some embodiments, the modem processor may pass to the application processor received data packets that do not meet blocking criteria of the filters.

Referring to FIG. 5B, the application processor may configure firewall rules in operation 502 and may save the firewall rules in a data structure in operation 504 as described.

In operation 532, the application processor may send to the modem processor firewall rules associated with one or more user plane connections that are maintained by the modem processor (indicated by the shaded fields).

In operation 534, the modem processor receives the firewall rules associated with one or more user plane connections that are maintained by the modem processor (indicated by the shaded fields).

In operation 510, the modem processor may generate filters from the received firewall rules, and in operation 512, the modem processor may screen packets using the filters, as described.

Referring to FIG. 5C, the application processor may configure firewall rules in operation 502 and may save the firewall rules in a data structure in operation 504, as described.

In operation 542, the application processor may generate filters from the firewall rules. In some embodiments, the application processor may generate the filters in a data structure, such as the data structure of the filters 550. In some embodiments, the generated filters are executable by the modem processor.

In operation 544, the application processor sends the filters to the modem processor.

In operation 546, the modem processor receives the filters. The modem processor may screen packets using the filters in operation 512, as described.

Referring to FIG. 5D, the application processor may configure firewall rules in operation 502 and may save the firewall rules in a data structure in operation 504, as described.

In operation 552, the application processor may generate filters based on firewall rules associated with one or more user plane connections that are maintained by the modem processor (indicated by the shaded fields).

In operation 534, the modem processor receives the firewall rules associated with one or more user plane connections that are maintained by the modem processor (indicated by the shaded fields). In some embodiments, the application processor may generate the filters in a data structure, such as the data structure of the filters 560. In some embodiments, the generated filters are executable by the modem processor.

In operation 554, the application processor sends the filters to the modem processor.

The modem processor receives the filters in operation 546, and may screen packets using the filters in operation 512, as described.

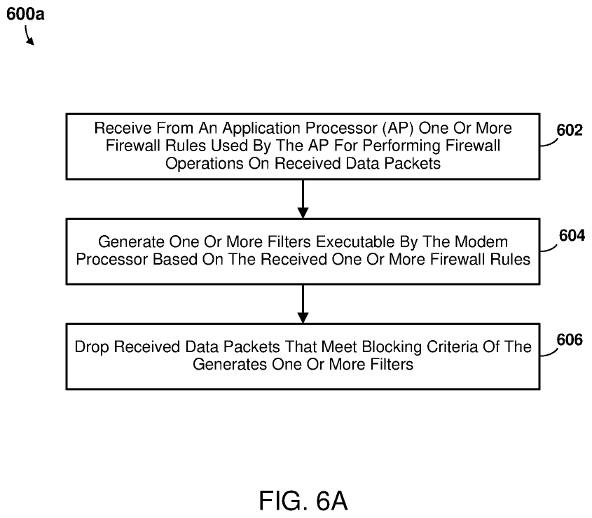

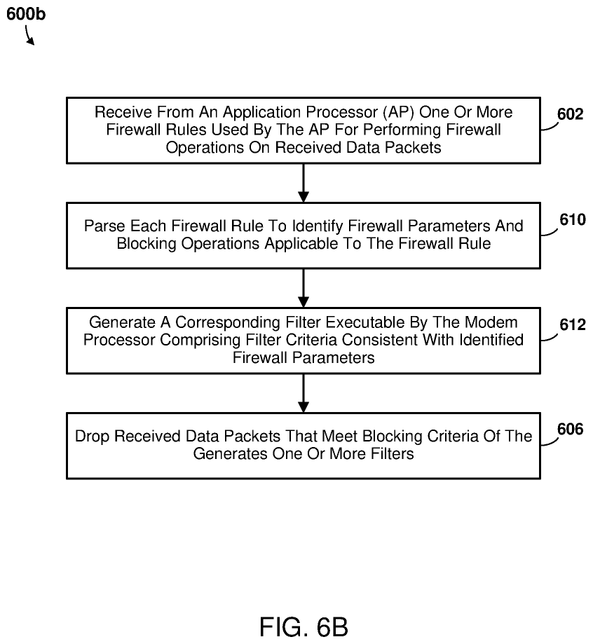

FIG. 6A is a process flow diagram illustrating a method 600a performed by a modem processor of a modem in accordance with various embodiments. With reference to FIGS. 1A-6A, the operations of the method 600a may be performed by a processor (such as the processor 210, 212, 214, 216, 218, 252, 260, 404) of a device (such as the UE 120a-120e, 200, 320, 400, 800). The processor may be a modem processor or a processor coupled to or controlling the modem, and therefore is referred to generally as a “modem processor.”

In block 602, the modem processor may receive from an application processor one or more firewall rules (e.g., 522) used by the application processor for performing firewall operations on received data packets. In some embodiments, the modem processor may receive from the application processor one or more firewall rules applicable only to one or more user plane connections maintained by the modem (e.g., EPS Bearers, PDU Sessions, or another suitable user plane connection). In some embodiments, the modem processor may receive from the application processor firewall rules applicable only to user plane connections maintained by the modem. Means for performing functions of the operations in block 602 may include the modem processor (e.g., 212, 252, 404) executing the firewall rule module 410 and a wireless transceiver (e.g., 266).

In block 604, the modem processor may generate one or more filters executable by the modem processor based on the received one or more firewall rules. Said another way, the modem processor may generate one or more filters that, when executed in the modem, will drop (i.e., not send to the application processor) the same data packets that the application processor would block or drop when executing the one or more firewall rules if the data packets were received from the modem. For example, the modem processor may generate the filters 524 that are executable by the modem processor. In some embodiments, the modem processor may generate one or more filters based on received one or more firewall rules associated with one or more user plane connections (e.g., EPS Bearers, PDU Sessions, or another suitable user plane connection). In such embodiments, the firewall rules received from the applications processor may be limited to the active user plan connections (i.e., sources or bearers of data packets) maintained by the modem, and thus the generated filters will be limited to the same user plane connections. Means for performing functions of the operations in block 604 may include the modem processor (e.g., 212, 252, 404) executing the filter module 412.

In block 606, the modem processor may drop received data packets that meet blocking criteria of the generated one or more filters. Said another way, when a data packet is received that satisfies or meets one or more of the filters generated in block 604, that data packet will receive no further processing and will not be passed to the applications processor. In this manner, the applications processor is saved from having to power up to perform the firewall rules on and then block or drop the data packet. Means for performing functions of the operations in block 604 may include the modem processor (e.g., 212, 252, 404) executing the packet handling module 414.

FIG. 6B is a process flow diagram illustrating operations 600b that may be performed by a modem processor of a modem as part of the method 600a in accordance with various embodiments. With reference to FIGS. 1A-6B, the operations of the method 600a may be performed by a processor (such as the processor 210, 212, 214, 216, 218, 252, 260, 404) of a device (such as the UE 120a-120e, 200, 320, 400, 800). The processor may be a modem processor or a processor coupled to or controlling the modem, and therefore is referred to generally as a “modem processor.”

In block 602, the modem processor may receive from an application processor one or more firewall rules used by the application processor for performing firewall operations on received data packets, as described for the like numbered block in the method 600a.

In block 610, the modem processor may parse each firewall rule to identify firewall parameters and blocking operations applicable to the firewall rule. The operations in block 610 may include identifying in the firewall rule information parameters defining data packet criteria for blocked, and any operations that should be performed on data packets matching the parameters. Means for performing functions of the operations in block 610 may include the modem processor (e.g., 212, 252, 404) executing the filter module 412.

In block 612, the modem processor may generate a corresponding filter executable by the modem processor comprising filter criteria consistent with identified firewall parameters. For example, in block 612 the modem processor may generate a filter based on the firewall rule information parameters identified in block 610, and associate an appropriate filter action (e.g., dropping the packet) based on any operations that should be performed identified in block 610. Means for performing functions of the operations in block 612 may include the modem processor (e.g., 212, 252, 404) executing the filter module 412.

In block 606, the modem processor may drop received data packets that meet blocking criteria of the generated one or more filters as described for the like numbered block in the method 600a.

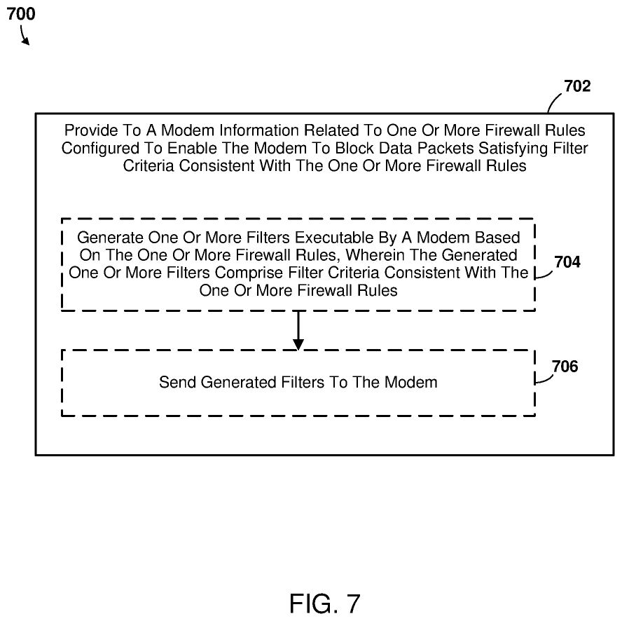

FIG. 7 is a process flow diagram illustrating a method 700 performed by an application processor of a device in accordance with various embodiments. With reference to FIGS. 1A-7, the operations of the method 700 may be performed by a processor (such as the processor 210, 214, 216, 218, 260, 424) of a device (such as the UE 120a-120e, 200, 320, 400, 800) The processor may be an application processor or another processor configured to perform operations of an application processor, and therefore is referred to generally as an “application processor.”

In block 702, the application processor may provide to a connected modem information related to one or more firewall rules, and provide the information in a configuration that will enable the modem to drop or block data packets satisfying filter criteria consistent with the one or more firewall rules. In some embodiments, the application processor may send to the modem all firewall rules that are implemented by the application processor. In some embodiments, the application processor may send to the modem only those firewall rules that are applicable to data sources being handled by the modem, such as one or more user plane connections maintained by the modem (e.g., (e.g., EPS Bearers, PDU Sessions, or another suitable user plane connection). Means for performing functions of the operations in block 702 may include the application processor (e.g., 210, 214, 216, 218, 260, 424) executing the firewall rule module 430.

In some embodiments, instead of providing the firewall rules to the modem, the application processor may generate one or more filters executable by a modem based on the one or more firewall rules in optional block 704. In optional block 704 it is the application processor (instead of the modem processor) that generates one or more filters that include filter criteria consistent with the one or more firewall rules. In some embodiments, the application processor may generate the one or more filters with filter criteria consistent with firewall parameters of the one or more firewall rules. In some embodiments, the application processor may generate one or more filters only for those firewall rules that are applicable to data sources being handled by the modem, such as one or more user plane connections maintained by the modem (e.g., (e.g., EPS Bearers, PDU Sessions, or another suitable user plane connection). Means for performing functions of the operations in optional block 704 may include the application processor (e.g., 210, 214, 216, 218, 260, 424) executing the filter module 434.

In optional block 706, the application processor may send the generated filters to the modem. Means for performing functions of the operations in optional block 706 may include the application processor (e.g., 210, 214, 216, 218, 260, 424) executing the filter module 434.

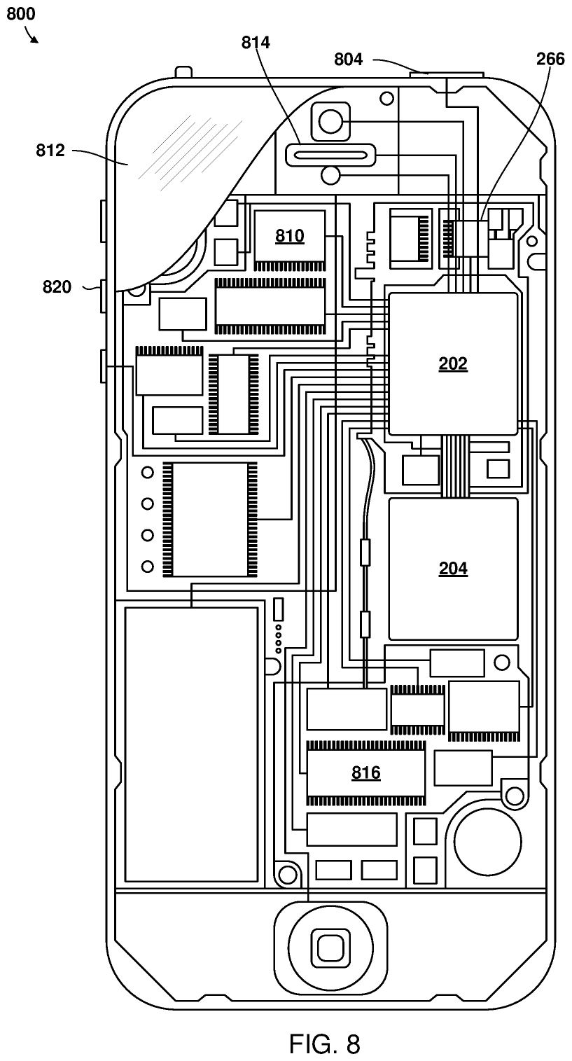

FIG. 8 is a component block diagram of a UE 800 suitable for use with various embodiments. With reference to FIGS. 1A-8, various embodiments may be implemented on a variety of UEs 800 (for example, the UEs 120a-120e, 200, 320, 402, 404), an example of which is illustrated in FIG. 8 in the form of a smartphone. The UE 800 may include a first SOC 202 (for example, a SOC-CPU) coupled to a second SOC 204 (for example, a 5G capable SOC). The first and second SOCs 202, 204 may be coupled to internal memory 816, a display 812, and to a speaker 814. Additionally, the UE 800 may include an antenna 804 for sending and receiving electromagnetic radiation that may be connected to a wireless transceiver 266 coupled to one or more processors in the first and/or second SOCs 202, 204. The UE 800 may include menu selection buttons or rocker switches 820 for receiving user inputs. The UE 800 may include a sound encoding/decoding (CODEC) circuit 810, which digitizes sound received from a microphone into data packets suitable for wireless transmission and decodes received sound data packets to generate analog signals that are provided to the speaker to generate sound. One or more of the processors in the first and second SOCs 202, 204, wireless transceiver 266 and CODEC 810 may include a digital signal processor (DSP) circuit (not shown separately).

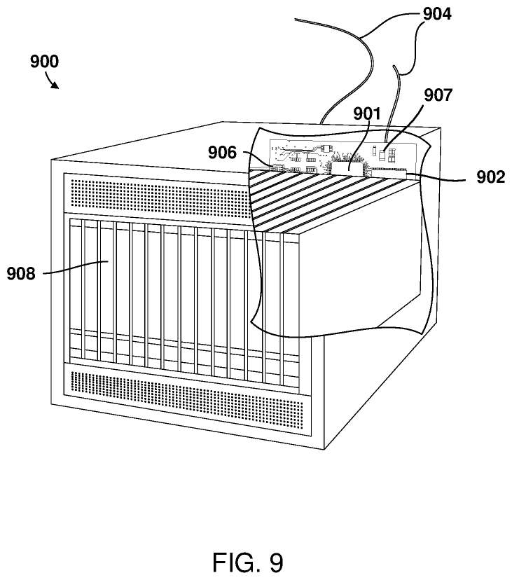

FIG. 9 is a component block diagram of a network device suitable for use with various embodiments. Such network devices (e.g., network device 110a-110d, 350) may include at least the components illustrated in FIG. 9. With reference to FIGS. 1A-9, the network device 900 may typically include a processor 901 coupled to volatile memory 902 and a large capacity nonvolatile memory, such as a disk drive 908. The network device 900 also may include a peripheral memory access device 906 such as a floppy disc drive, compact disc (CD) or digital video disc (DVD) drive coupled to the processor 901. The network device 900 also may include network access ports 904 (or interfaces) coupled to the processor 901 for establishing data connections with a network, such as the Internet or a local area network coupled to other system computers and servers. The network device 900 may include one or more antennas 907 for sending and receiving electromagnetic radiation that may be connected to a wireless communication link. The network device 900 may include additional access ports, such as USB, Firewire, Thunderbolt, and the like for coupling to peripherals, external memory, or other devices.

The processors of the UE 800 and the network device 900 may be any programmable microprocessor, microcomputer or multiple processor chip or chips that can be configured by software instructions (applications) to perform a variety of functions, including the functions of some implementations described below. In some wireless devices, multiple processors may be provided, such as one processor within an SOC 204 dedicated to wireless communication functions and one processor within an SOC 202 dedicated to running other applications. Software applications may be stored in the memory 816, 902 before they are accessed and loaded into the processor. The processors may include internal memory sufficient to store the application software instructions.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the methods and operations disclosed herein may be substituted for or combined with one or more operations of the methods and operations disclosed herein.

Implementation examples are described in the following paragraphs. While some of the following implementation examples are described in terms of example methods, further example implementations may include: the example methods discussed in the following paragraphs implemented by a modem processor or application processor including a modem processor or application processor configured with processor-executable instructions to perform operations of the methods of the following implementation examples; the example methods discussed in the following paragraphs implemented by a modem processor or application processor including means for performing functions of the methods of the following implementation examples; and the example methods discussed in the following paragraphs may be implemented as a non-transitory processor-readable storage medium having stored thereon processor-executable instructions configured to cause a modem processor or application processor to perform the operations of the methods of the following implementation examples.

Example 1. A method performed by a modem processor of a modem, including: receiving from an application processor one or more firewall rules used by the application processor for performing firewall operations on received data packets; generating one or more filters executable by the modem processor based on the received one or more firewall rules; and dropping received data packets that meet blocking criteria of the generated one or more filters.

Example 2. The method of example 1, in which generating one or more filters executable by the modem processor based on the received one or more firewall rules includes generating one or more filters based on received one or more firewall rules associated with one or more user plane connections maintained by the modem.

Example 3. The method of either of example 1 or 2, in which generating one or more filters executable by the modem processor based on the received one or more firewall rules includes: parsing each firewall rule to identify firewall parameters and blocking operations applicable to the firewall rule; and generating a corresponding filter executable by the modem processor including filter criteria consistent with identified firewall parameters.

Example 4. The method of any of examples 1-3, in which receiving from an application processor one or more firewall rules includes receiving from the application processor firewall rules applicable only to user plane connections maintained by the modem.

Example 5. A method performed by an application processor, including: providing to a modem information related to one or more firewall rules configured to enable the modem to block data packets satisfying filter criteria consistent with the one or more firewall rules.

Example 6. The method of example 5, in which providing to a modem information related to one or more firewall rules includes sending to the modem all firewall rules configured for use by the application processor.

Example 7. The method of example 5, in which providing to a modem information related to one or more firewall rules includes sending to the modem only firewall rules that are applicable to one or more user plane connections maintained by the modem.

Example 8. The method of example 5, in which providing to a modem information related to one or more firewall rules configured to enable the modem to block data packets satisfying filter criteria consistent with the one or more firewall rules includes generating one or more filters executable by a modem based on the one or more firewall rules, in which the generated one or more filters comprise filter criteria consistent with the one or more firewall rules.

Example 9. The method of example 8, in which generating one or more filters executable by the modem based on one or more firewall rules includes generating the one or more filters with filter criteria consistent with firewall parameters of the one or more firewall rules.

As used in this application, the terms “component,” “module,” “system,” and the like are intended to include a computer-related entity, such as, but not limited to, hardware, firmware, a combination of hardware and software, software, or software in execution, which are configured to perform particular operations or functions. For example, a component may be, but is not limited to, a process running in a processor, a processor, an object, an executable, a thread of execution, a program, or a computer. By way of illustration, both an application running on a wireless device and the wireless device may be referred to as a component. One or more components may reside within a process or thread of execution and a component may be localized on one processor or core or distributed between two or more processors or cores. In addition, these components may execute from various non-transitory computer readable media having various instructions or data structures stored thereon. Components may communicate by way of local or remote processes, function or procedure calls, electronic signals, data packets, memory read/writes, and other known network, computer, processor, or process related communication methodologies.

A number of different cellular and mobile communication services and standards are available or contemplated in the future, all of which may implement and benefit from the various embodiments. Such services and standards include, e.g., third generation partnership project (3GPP), long term evolution (LTE) systems, third generation wireless mobile communication technology (3G), fourth generation wireless mobile communication technology (4G), fifth generation wireless mobile communication technology (5G) as well as later generation 3GPP technology, global system for mobile communications (GSM), universal mobile telecommunications system (UMTS), 3GSM, general packet radio service (GPRS), code division multiple access (CDMA) systems (e.g., cdmaOne, CDMA1020TM), enhanced data rates for GSM evolution (EDGE), advanced mobile phone system (AMPS), digital AMPS (IS-136/TDMA), evolution-data optimized (EV-DO), digital enhanced cordless telecommunications (DECT), Worldwide Interoperability for Microwave Access (WiMAX), wireless local area network (WLAN), Wi-Fi Protected Access I & II (WPA, WPA2), and integrated digital enhanced network (iDEN). Each of these technologies involves, for example, the transmission and reception of voice, data, signaling, and/or content messages. It should be understood that any references to terminology and/or technical details related to an individual telecommunication standard or technology are for illustrative purposes only, and are not intended to limit the scope of the claims to a particular communication system or technology unless specifically recited in the claim language.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an,” or “the” is not to be construed as limiting the element to the singular.

Various illustrative logical blocks, modules, components, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of the claims.

The hardware used to implement various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A modem, comprising:
a modem processor configured to:
receive from an application processor one or more firewall rules used by the application processor for performing firewall operations on received data packets;
generate one or more filters executable by the modem processor based on the received one or more firewall rules; and
drop received data packets that meet blocking criteria of the generated one or more filters.

2. The modem of claim 1, wherein generating one or more filters executable by the modem processor based on the received one or more firewall rules comprises generating one or more filters based on received one or more firewall rules associated with one or more user plane connections maintained by the modem.

3. The modem of claim 1, wherein generating one or more filters executable by the modem processor based on the received one or more firewall rules comprises:
parsing each firewall rule to identify firewall parameters and blocking operations applicable to the firewall rule; and
generating a corresponding filter executable by the modem processor comprising filter criteria consistent with identified firewall parameters.

4. The modem of claim 1, wherein receiving from an application processor one or more firewall rules comprises receiving from the application processor firewall rules applicable only to user plane connections maintained by the modem.

5. A method performed by a modem processor of a modem, comprising:
receiving from an application processor one or more firewall rules used by the application processor for performing firewall operations on received data packets;
generating one or more filters executable by the modem processor based on the received one or more firewall rules; and
dropping received data packets that meet blocking criteria of the generated one or more filters.

6. The method of claim 5, wherein generating one or more filters executable by the modem processor based on the received one or more firewall rules comprises generating one or more filters based on received one or more firewall rules associated with one or more user plane connections maintained by the modem.

7. The method of claim 5, wherein generating one or more filters executable by the modem processor based on the received one or more firewall rules comprises:
parsing each firewall rule to identify firewall parameters and blocking operations applicable to the firewall rule; and
generating a corresponding filter executable by the modem processor comprising filter criteria consistent with identified firewall parameters.

8. The method of claim 5, wherein receiving from an application processor one or more firewall rules comprises receiving from the application processor firewall rules applicable only to user plane connections maintained by the modem.

9. An application processor, configured to:
provide to a modem information related to one or more firewall rules configured to enable the modem to block data packets satisfying filter criteria consistent with the one or more firewall rules.

10. The application processor of claim 9, wherein providing to a modem information related to one or more firewall rules comprises sending to the modem all firewall rules configured for use by the application processor.

11. The application processor of claim 9, wherein providing to a modem information related to one or more firewall rules comprises sending to the modem only firewall rules that are applicable to one or more user plane connections maintained by the modem.

12. The application processor of claim 9, wherein providing to a modem information related to one or more firewall rules configured to enable the modem to block data packets satisfying filter criteria consistent with the one or more firewall rules comprises generating one or more filters executable by a modem based on the one or more firewall rules, wherein the generated one or more filters comprise filter criteria consistent with the one or more firewall rules.

13. The application processor of claim 12, wherein generating one or more filters executable by the modem based on one or more firewall rules comprises generating the one or more filters with filter criteria consistent with firewall parameters of the one or more firewall rules.

14. A method performed by an application processor, comprising:
providing to a modem information related to one or more firewall rules configured to enable the modem to block data packets satisfying filter criteria consistent with the one or more firewall rules.

15. The method of claim 14, wherein providing to a modem information related to one or more firewall rules comprises sending to the modem all firewall rules configured for use by the application processor.

16. The method of claim 14, wherein providing to a modem information related to one or more firewall rules comprises sending to the modem only firewall rules that are applicable to one or more user plane connections maintained by the modem.

17. The method of claim 14, wherein providing to a modem information related to one or more firewall rules configured to enable the modem to block data packets satisfying filter criteria consistent with the one or more firewall rules comprises generating one or more filters executable by a modem based on the one or more firewall rules, wherein the generated one or more filters comprise filter criteria consistent with the one or more firewall rules.

18. The method of claim 17, wherein generating one or more filters executable by the modem based on one or more firewall rules comprises generating the one or more filters with filter criteria consistent with firewall parameters of the one or more firewall rules.
